(19) United States
(12) Patent Application Publication
(10) Pub. No.: US 2011/0062933 A1
(43) Pub. Date: Mar. 17, 2011

(54) FULL CYCLE AC POWER CONTROL

(75) Inventors: Nam Tosuntikool, Hillsboro, OR (US); Dwight Howell, Beaverton, OR (US)

(73) Assignee: LEVITON MANUFACTURING CO., INC., Melville, NY (US)

(21) Appl. No.: 12/560,356

(22) Filed: Sep. 15, 2009

(51) Int. Cl. H02J 3/00; H01H 9/56

(52) U.S. Cl. 323/304; 200/19.01

(57) ABSTRACT

A method includes selectively applying full cycles of AC power to a load. The cycles may have first and second states such as full on and full off states. The cycles may be arranged in groups in a pattern. The pattern may have a length that is shorter than a perceptible response time of the load. Different patterns may be used for different power levels.

### BACKGROUND

The amount of power transferred from an alternating current (AC) power source to an electrical load such as a motor, heater, etc., must often be controlled to match the power required by the load. For example, a motor for a fan or a pump may need to run at different speeds depending on the amount of air or fluid to be moved. As another example, an electrical resistance heater may need to operate at various points between full power and off depending on the particular heating load.

Numerous methods have been devised for controlling AC power including phase control, resistive voltage reduction, and damping networks. With AC phase control, switching devices such as silicon controlled rectifiers (SCRs), triacs, transistors, etc., are used to switch the power source on at a variable point or phase angle in the AC line cycle. The switching device either turns itself off automatically or is turned off at the end of the AC line cycle. The phase angle at which the switching device is turned on determines the average power delivered to the load.

With resistive voltage reduction, a variable power resistor in the form of a potentiometer or rheostat is connected in series between the AC power source and the load. As the power resistor is swept through its resistance range, the voltage seen by the load, and therefore, the power transferred to the load, is varied.

A damping network typically includes a parallel and/or series combination of resistors and capacitors coupled in series between the power source and the load. The component values are selected so that only a fixed portion of the power available from the AC source is transferred to the load. To provide multiple power levels, multiple damping networks, each designed to transfer a different amount of power to the load, are switched into and out of the load circuit.

### BRIEF DESCRIPTION OF THE DRAWINGS

FIG. 1 illustrates a prior art phase control technique for controlling AC power to a fan motor.

FIG. 2 illustrates another prior art technique for controlling AC power to a fan motor.

FIG. 3 illustrates an embodiment of a method for controlling power to a load according to some inventive principles of this patent disclosure.

FIG. 4 illustrates an embodiment of a cycle pattern according to some inventive principles of this patent disclosure.

FIG. 5 illustrates another embodiment of a cycle pattern according to some inventive principles of this patent disclosure.

FIG. 6 illustrates another embodiment of a method for controlling power to a load according to some inventive principles of this patent disclosure.

FIG. 7 illustrates another embodiment of a method for controlling power to a load according to some inventive principles of this patent disclosure.

FIG. 8 illustrates another embodiment of a method for controlling power to a load according to some inventive principles of this patent disclosure.

FIG. 9 illustrates an embodiment of a system for controlling power to a load according to some inventive principles of this patent disclosure.

FIG. 10 illustrates another embodiment of a system for controlling power to a load according to some inventive principles of this patent disclosure.

FIG. 11 illustrates an embodiment of a fan speed controller according to some inventive principles of this patent disclosure.

FIG. 12 illustrates an embodiment of a power switching circuit according to some inventive principles of this patent disclosure.

FIG. 13 illustrates another embodiment of a power switching circuit according to some inventive principles of this patent disclosure.

FIG. 14 illustrates another embodiment of a power switching circuit according to some inventive principles of this patent disclosure.

FIG. 15 illustrates an embodiment of a wiring device according to some inventive principles of this patent disclosure.

### DETAILED DESCRIPTION

Selecting an AC power control technique for a particular application typically involves making tradeoffs between various factors such as performance, convenience, cost (including cost for manufacturing, installation, operation, etc.), energy conservation, aesthetics, etc. In some applications, the tradeoffs are particularly difficult to balance, and adequate solutions have not been found.

One example of such an AC power control application is controlling the speed of a fan motor for exhaust, ventilation, cooling, etc., in building environments. Fan motors often need to run at different speeds depending on the rate at which air must be moved into, out of, and/or within a building. The design challenges are often compounded by the requirement that the fan speed controller must be located within an electrical box, such as a wallbox, which has limited space, cooling capacity, etc.

One prior art technique for controlling AC power to a fan uses resistive voltage reduction where a rheostat is connected in series with the fan. As the power resistor is swept through its resistance range, the voltage applied to the fan, and therefore its rotational speed, varies. Rheostats that are capable of controlling the speed of even smaller fan motors are expensive, bulky, and dissipate a large amount of heat. Under some operating conditions, the rheostat may dissipate more heat than the fan itself. This heat is difficult to remove from the wallbox in which the rheostat is mounted. Rheostats also tend to be difficult to operate because actuators for linear or rotary rheostats typically require a large amount of force to operate.

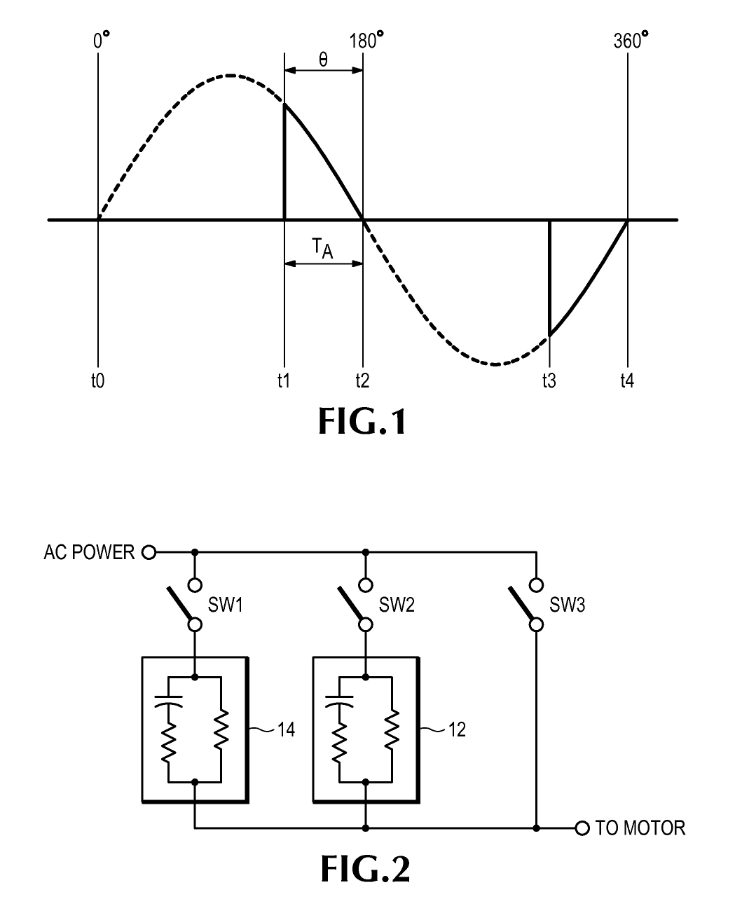

Another prior art technique for controlling power to a fan motor involves AC phase control as illustrated in FIG. 1. The voltage of the AC power source is shown as a broken line. An AC line cycle has a positive half cycle beginning at time t0 and ending at a midpoint zero crossing at t2. The AC line cycle then has a negative half cycle beginning at t2 ending at t4. At time t1, a switch is turned on to connect the power source to the load. The switch continues conducting during period T_{A} which is related to the conduction angle θ. The conduction angle is 180 degrees if the switch turns on at t0, 90 degrees if the switch turns on at the peak of the positive half cycle, and 0 degrees at time t2. At the zero cross at time t2, the switch turns off, either by itself in the case of a thyristor such as an SCR or triac, or by action of a control signal in the case of a transistor. By varying the conduction angle, the average power delivered to the load may be varied. The greater the area of the solid waveform, the greater the percentage of power delivered to the load.

Phase control presents several problems. For example, if the switch is turned on at any phase angle that is not close to 180 or zero degrees, the abrupt increase in current (di/dt) generates electromagnetic interference (EMI) and noise in the switching circuit and fan motor where windings may act as loudspeakers. This effect is especially pronounced near the peaks of the AC waveform where the di/dt is at a maximum. EMI is harmful to both the switching circuit and other equipment. Thus, bulky and expensive EMI filters may be required. EMI filters also dissipate additional heat which must be removed from the circuitry. Moreover, the di/dt current surges may be destructive to the switching device which must therefore be oversized to accommodate high peak currents.

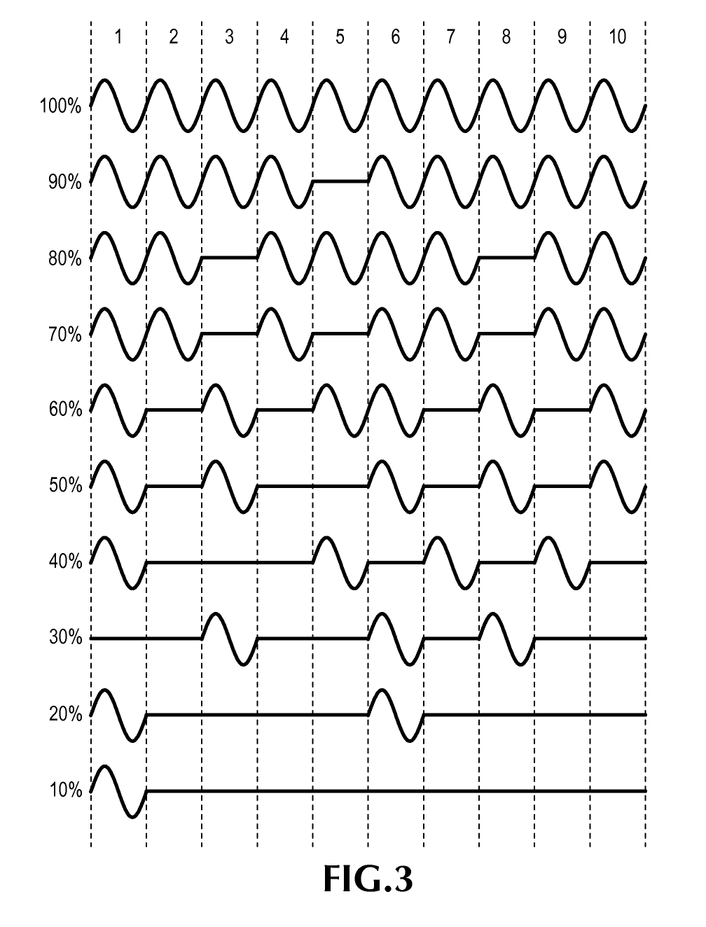

Another prior art technique for controlling power to a fan motor involves the use of multiple damping networks as illustrated in the system of FIG. 2 which provides three different fan speeds. At full power, only switch S3 is closed, and the complete AC voltage is applied to the fan motor 10. At medium power, only switch S2 is closed, so a first damping network 12 is connected in series between the power source and the motor. The first damping network is designed to divide the AC voltage down to a level that causes the motor to run at a medium speed. At low power, only switch S1 is closed, so a second damping network 14 is connected in series between the power source and the motor. The second damping network is designed to divide the AC voltage down to a lower level that causes the motor to run at a low speed.

Damping networks also present several problems. For example, each damping network must have an impedance that is coordinated with the impedance of the fan motor. Thus, many different models of fan speed controllers must be designed, manufactured, stocked, etc. This also increases the possibility of mistakenly installing the wrong controller which is costly and time consuming to replace and presents a potential safety hazard as well.

Another problem is that multiple switches are required to connect the different damping networks to the motor. These switches must carry all of the fan load current. If implemented as a multi-position mechanical switch, it may require a large amount of force to actuate, and the contacts must be numerous and heavy enough to carry the load current for all speed settings as well as high voltage transients caused by switching an inductive load. If implemented as solid state devices such as triacs, SCRs, etc., multiple sets of devices are required, as well as the associated drive circuitry which further increases the cost. Another problem is the heat generated by the damping networks which is wasteful and must be removed from the wallbox or other enclosure in which the fan speed controller is mounted.

FIG. 3 illustrates an embodiment of a method for controlling power to a load according to some inventive principles of this patent disclosure. The method involves selectively applying full cycles of AC power to the load, interspersed with full cycles during which no power is applied. By varying the number of ON cycles relative to the number of OFF cycles, the amount of power delivered to the load may be varied.

As shown in FIG. 3, different patterns of ON and OFF cycles may be used depending on the power level. In this example, each pattern has a length of ten cycles. At 100 percent power, AC power is applied to the load during all ten of the cycles. At 90 percent power, the power is applied to the load during a group of four ON cycles (cycles 1 through 4); no power is applied during cycle 5; and power is then applied again during a group of five ON cycles (cycles 6-10). Thus, at 90 percent power, the pattern includes a total of nine ON cycles and one OFF cycle. The time-averaged or overall power is therefore reduced by 10 percent compared to the pattern for 100 percent power. At 50 percent power, five ON cycles and five OFF cycles are distributed throughout the pattern. At ten percent power, each pattern includes one ON cycle followed by a group of nine OFF cycles.

In this example, after cycle 10 is complete, the pattern for the specific power level is repeated beginning at cycle 1. In some other embodiments, however, non-repeating patterns may be used. In yet other embodiments, a random or quasi-random sequence of groups of ON cycles and OFF cycles may be used to maintain some average power level. In still other embodiments, a sequence of different patterns may be repeated to provide a finer level of granularity in the average power level.

A group of cycles may include one or more consecutive cycles during which a similar level, type, form, etc. of power is applied to a load. Thus, a group of ON cycles may include one or more consecutive ON cycles during which full power is applied to the load, a group of OFF cycles may include or one or more consecutive OFF cycles during which no power is applied to the load, a group of low voltage cycles may include one or more consecutive cycles during which a reduced voltage is applied to the load, etc.

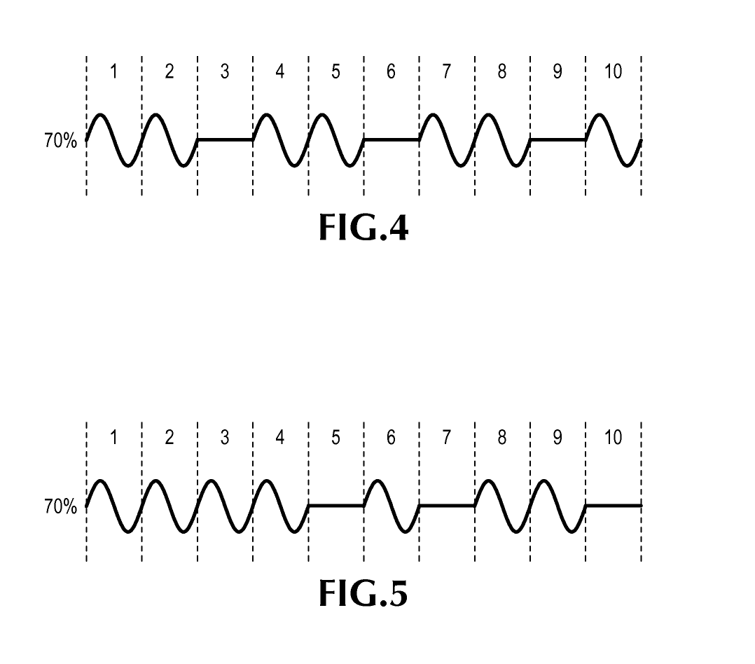

In some applications, it may be beneficial for the groups of ON cycles to have the most uniform number of cycles possible and to be spaced as evenly as possible. FIG. 4 illustrates an example of a 10-cycle pattern at 70 percent power where the groups of ON cycles are relatively uniform and evenly spaced. In this embodiment, the groups of cycles have the most uniform number of full cycles permitted by the pattern length and are distributed as uniformly as permitted by the pattern length. Such an arrangement may, for example, provide for smoother operation of the load or loads.

In other applications, it may be beneficial to purposely vary the number of ON cycles in each group and/or spacing of groups. FIG. 5 illustrates such an example where one group has four ON cycles (cycles 1-4), another group has a single ON cycle (cycle 6), and the other group has two ON cycles (cycles 8 and 9). Such an arrangement may, for example, prevent the formation of resonant behavior or beat frequencies caused by the interaction of the ON cycles with the load or loads.

In yet other applications, the load or loads may be relatively insensitive to the particular groupings of ON cycles in the pattern. Thus, the specific pattern may be determined based on the ease of implementation rather than performance issues.

In some applications, the length or other characteristics of the pattern of full cycles may be coordinated with various characteristics of the load. As an example, it may be beneficial to keep the pattern length shorter than the perceptible response time of the load to prevent individual full cycles or groups of full cycles from causing perceptible fluctuations in the load.

For example, if a fan motor is abruptly switched from full power to completely off, it may take ¼ second for an observer to notice the motor is slowing down. Thus, a pattern length that is less than ¼ second may be adequate.

The perceptible response time may vary greatly for different types of loads. An incandescent lamp may create perceptible fluctuations in light output even with a pattern that is only a few cycles long at 60 Hz, whereas there may be no perceptible fluctuation in the output from a resistance heating element even with a cycle pattern that is a few seconds long. Similarly, an exhaust fan with a low-inertia squirrel-cage rotor may exhibit audible fluctuations when driven with a certain pattern length, whereas a ceiling fan with long, heavy blades may produce no perceptible speed fluctuations at all when driven with the same pattern length.

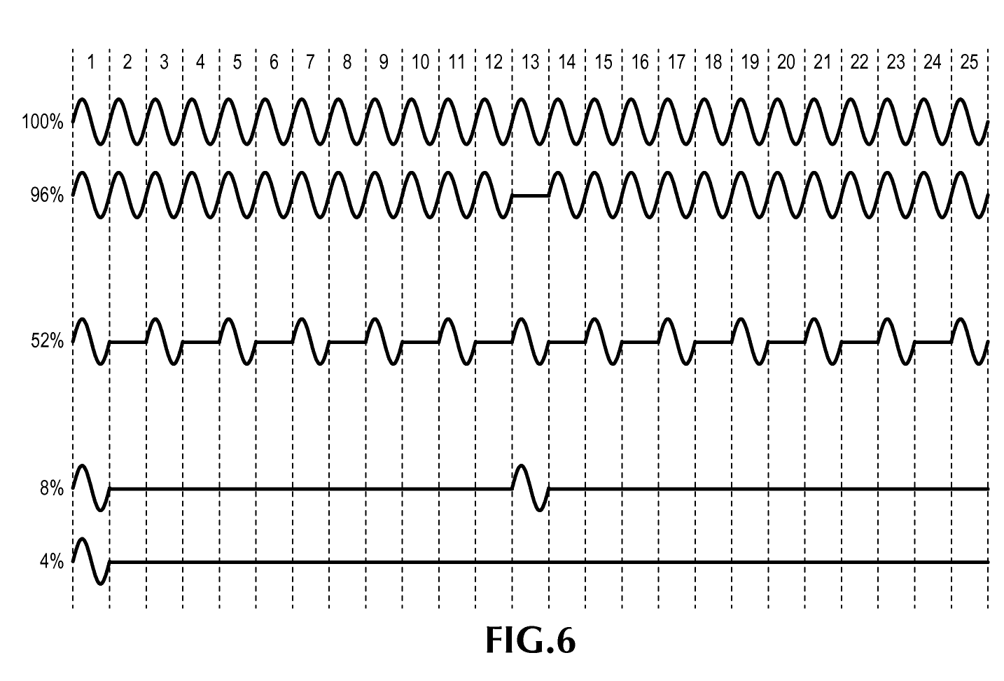

FIG. 6 illustrates another embodiment of a full cycle power control method, this one having 25 different power levels to provide power control in four percent increments. In this example, the pattern for each power level is 25 cycles long and repeats continuously. At 60 Hz, the 25 cycle pattern length requires 0.42 seconds to complete. For many applications this pattern length maybe short enough to prevent perceptible fluctuations in the power level of the load while still providing discrete power increments that are fine enough to appear as continuous control.

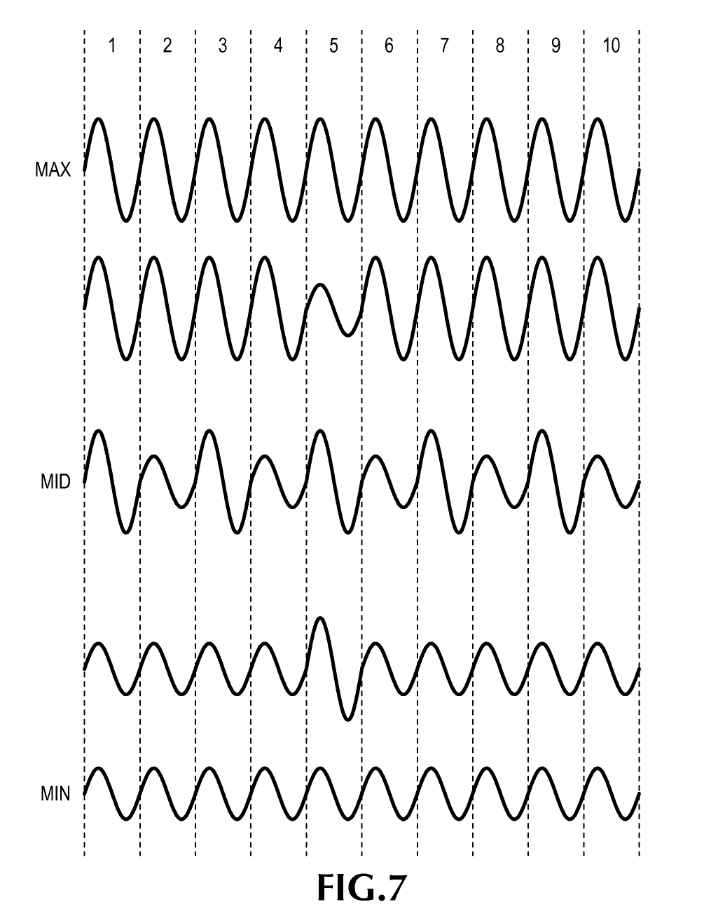

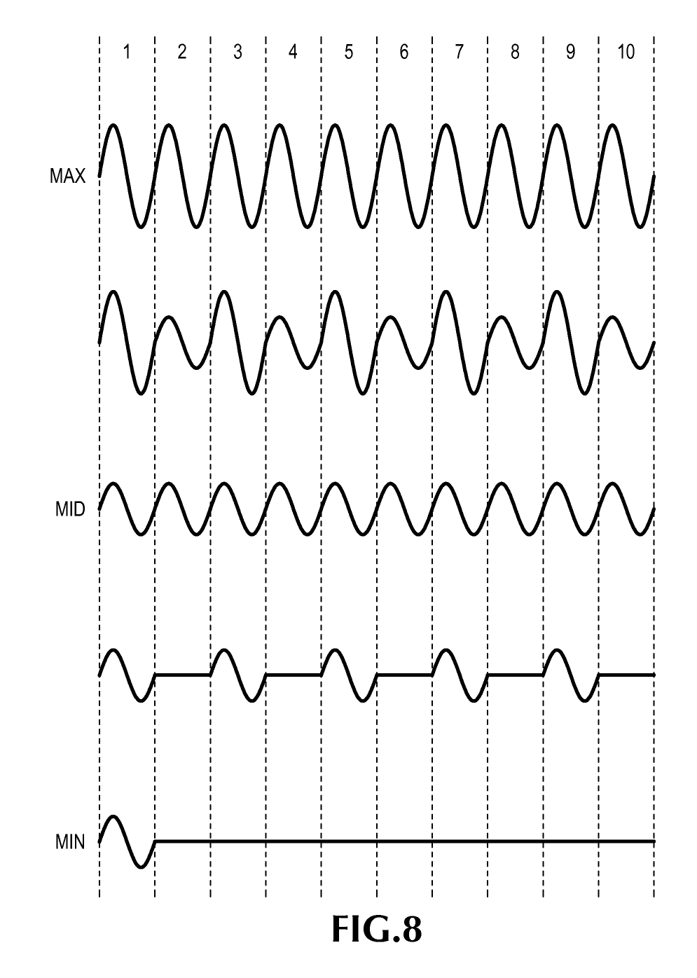

Some additional inventive principles of this patent disclosure relate to driving one or more loads with full cycles from more than one AC power source. In some embodiments, a load may be driven with cycles from a first AC power source having a relatively high voltage alternating with cycles from a second AC power source having a relatively low voltage. An example is illustrated in FIG. 7 where the power varies between a maximum, when the load is driven entirely by high voltage cycles, and a minimum, when the load is driven entirely by low voltage cycles. As a further elaboration, OFF cycles may be mixed in with the pattern to extend the low end of the power range as shown in FIG. 8.

In some other embodiments, full or partial cycles from other types of AC power sources may be combined to control the power to one or more loads. For example, cycles from one AC power source may be combined with cycles from one or more other AC power sources having different frequencies, waveforms, phases, impedances, etc., or various combinations thereof.

Depending on the implementation, controlling power to a load in accordance with some inventive principles of this patent disclosure may provide various benefits. For example, it may be possible to connect several loads in parallel and drive them with the same pattern of cycles and achieve uniform performance across all of the loads. Moreover, it may be possible to obtain this benefit even where there is a large disparity in the size, type, etc., of the parallel loads.

As another example, driving a load with full AC cycles in accordance with some inventive principles of this patent disclosure may reduce or eliminate noise, inrush current and/or EMI because the power may be switched at or near zero crossings. This may reduce or eliminate audible noise in the load, as well as electrical noise and/or EMI caused by switching when high levels of voltage and/or current are flowing through the switch. Thus, a full cycle may refer not only to a complete cycle of the AC power source where switching is right at the zero cross, but also to a substantially complete cycle where the switching is close enough to a zero cross to provide a beneficial result. Moreover, a full cycle may refer to full cycle of voltage, current, or other parameter. A pattern of full AC cycles may include some AC cycles that are less than full cycles, but still have enough full cycles to provide beneficial results.

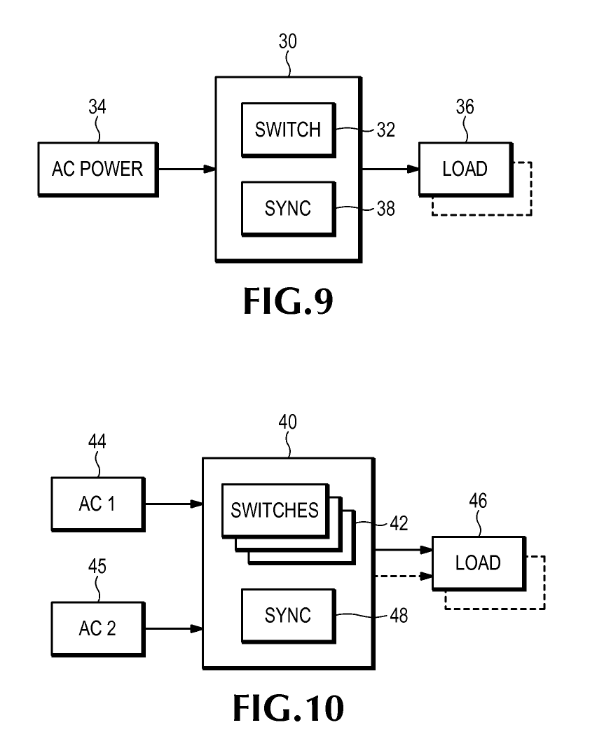

FIG. 9 illustrates an embodiment of a system for controlling power to a load according to some inventive principles of this patent disclosure. The system 30 of FIG. 9 includes a switch 32 to couple power from an AC power source 34 to one or more loads 36 in full cycles. The system also includes a synchronization feature 38 to enable the switch to synchronize with the AC power source. The switch 32 may be implemented with any suitable device including one or more triacs, SCRs, transistors, solid state or mechanical relays, etc. The synchronization feature 38 may be implemented with a separate hardware circuit such as a zero-cross detector, peak detector, etc., or it may be realized with software or firmware running on a microcontroller or other digital logic.

The AC power source 34 may include a common sinusoidal AC power source such as the 50/60 Hz power typically utilized throughout the world at various voltages. However other AC power sources with different frequencies, waveforms, voltages, etc., may be used. The AC waveform may also have an offset such that the waveform does not go negative during part of the cycle, but has a pulsating DC or hybrid characteristic, or is otherwise asymmetric.

The one or more electrical loads 36 may include motors, heaters, lights, actuators, or any other load where it may be beneficial to control the amount of power it receives from an AC power source.

FIG. 10 illustrates another embodiment of a system for controlling power to a load according to some inventive principles of this patent disclosure. The system 40 of FIG. 10 includes two or more switches 42 to couple power from two or more AC power sources 44,45 to one or more loads 46 in full cycles. The system also includes a synchronization feature 48 to enable the switches to synchronize with the AC power source.

The switches 42 and synchronization feature 48 may be implemented in any suitable manner as discussed above with respect to the embodiment of FIG. 9. The two or more AC power sources 44 and one or more loads 46 may include any suitable sources or loads as discussed above with respect to the embodiment of FIG. 9. The multiple switches in the embodiment of FIG. 10 enable the system to apply AC power in full cycles from more than one power source to one or more loads. For example, the system may mix cycles from AC sources having different voltages, frequencies, phases, waveforms, etc. In this context, each phase of a three-phase AC power source may be considered a separate AC power source.

In some embodiments, a control system having full cycle control according to the inventive principles may be realized as a wiring device which serves as a connection and control point for building wiring. In some embodiments, such a wiring device may be configured to fit inside a standard electrical box such as a wallbox, ceiling box, etc. In some other embodiments, such a wiring device maybe configured to fit in a central panelbox or other enclosure for building wiring.

In some other embodiments, a control system may be integral with an appliance such as a ceiling fan, lamp, heater, etc. In still other embodiments, a control system maybe included in a portable switching device that it may be removed from an interior or exterior building space without disconnecting any permanent building wiring. For example, the control system may be implemented with a cord-connected power strip that may be removed from a first office by unplugging it from a receptacle and moved to second office. In yet other embodiments, a control system may be implemented with a local switching device which may be connected to a load without any building wiring between the local switching device and the load. For example, a local switching device may be implemented with a receptacle that is mounted in a wall outlet and configured to connect to a load that is plugged in to the receptacle.

In some embodiments, a control system may be configured to fit in an accessible electrical box which can, for example, include a junction box that is accessible such as a wall box, a ceiling box, a floor box, or the like. Thus, accessible includes accessible to an end user. For example, a wall box installed in a wall with a trim plate would be an accessible electrical box.

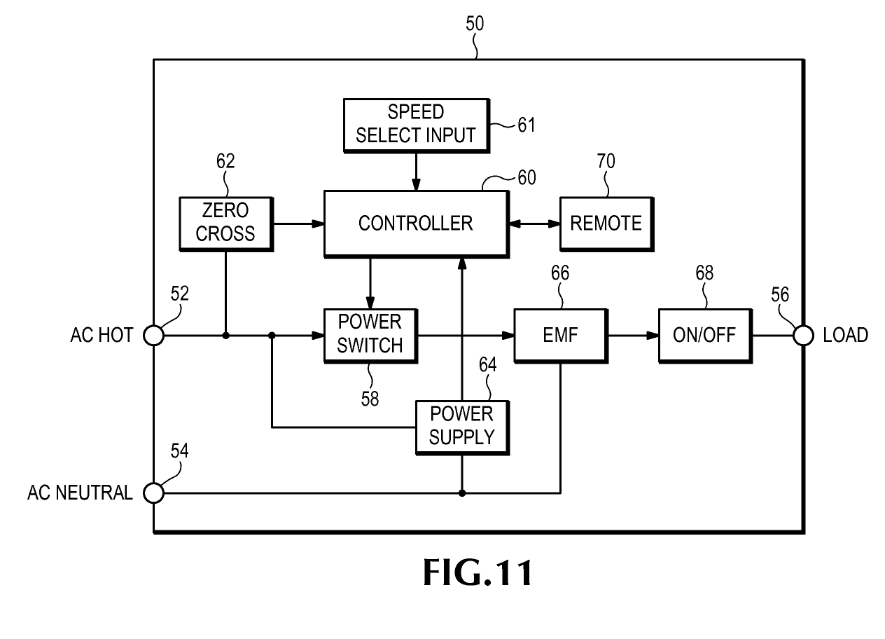

FIG. 11 illustrates an embodiment of a fan speed controller according to some inventive principles of this patent disclosure. The controller 50 of FIG. 11 includes an AC hot terminal 52 to receive power from an AC power source, an AC neutral terminal 54, and a load terminal 56 to couple AC power to one or more electrical loads. A power switch 58 controls the flow of power from the AC hot terminal to the load terminal in response to a controller 60. A zero-cross detection circuit 62 enables the controller to open and close the power switch at or near zero-crosses in the AC power source. The user can select the power level through a speed select input 61 which may include a slide switch having discrete positions for different speed settings or a continuous range of motion that may be discrete-ized by the controller. Alternatively, the speed select input may include a rotary switch or potentiometer, digital pushbuttons, toggle switches, or any other suitable form of input to select the fan speed.

The embodiment of FIG. 11 also includes a power supply 64 that generates suitable power to operate logic and other electronics in the controller. An electromotive force (EMF) filter 66 suppresses back EMF from the load. A mechanical ON/OFF switch 68 provides an air gap to isolate the load from the power source. A remote interface 70 may receive input commands from a handheld or other remote control through infrared (IR), radio frequency (RF), hardwired or any other suitable connection.

The components illustrated in FIG. 11 may be reconfigured in many different arrangements, and many features may be omitted and/or modified in various embodiments. For example, the ON/OFF switch and/or remote interface may not be included in some applications. Depending on the type of fan, the EMF filter may also be omitted. The AC neutral terminal may not be needed in some applications, and in others, the power supply, zero cross detector, controller, and/or speed select interface may be replaced by other components, combined in a unified component, or otherwise modified depending on the requirements of the specific application.

The controller 60 may be implemented in analog or digital hardware, software, firmware, or any suitable combination thereof. In some embodiments, the controller may include a microcontroller or other form of microprocessor which generates a gating signal to control the power switch. The patterns of ON and OFF cycles may be stored in lookup tables, generated through mathematical algorithms, or derived in any other suitable manner.

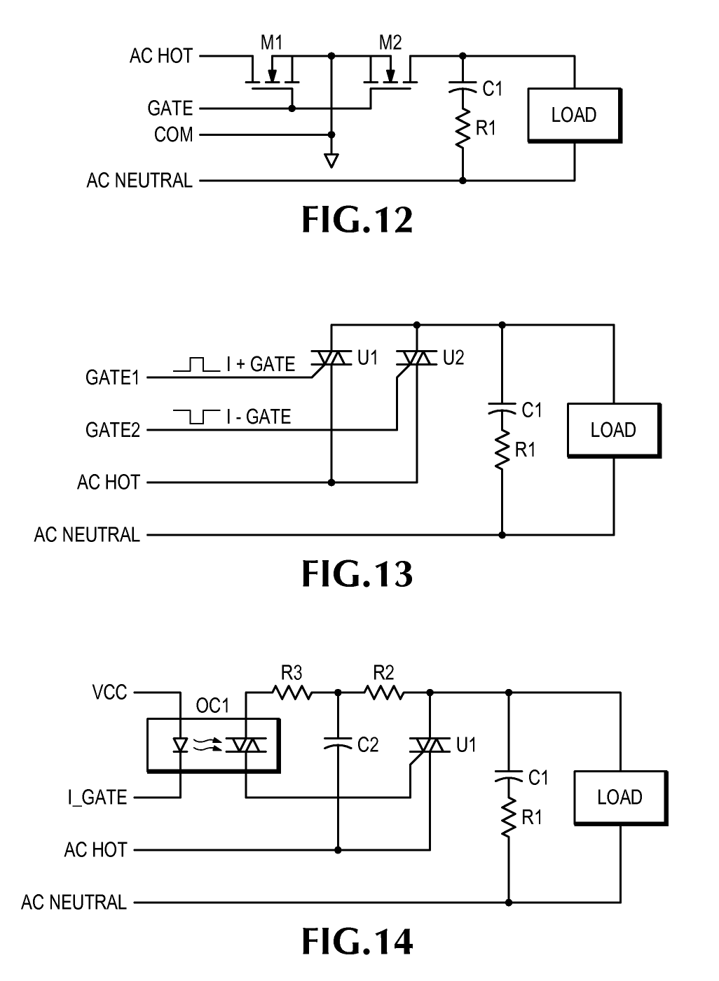

FIG. 12 illustrates an embodiment of a power switching circuit suitable for use with the fan speed controller of FIG. 11, as well as other embodiments of AC power controllers according to some inventive principles of this patent disclosure. The circuit of FIG. 12 includes two N-type metal-oxide field effect transistors (MOSFETs) M1 and M2 arranged in series between the hot terminal of the AC power source and the load. The sources of M1 and M2 are both connected to a control circuit common terminal COM, and their gates are both driven by a single gate signal GATE. Both transistors must be turned off to block the AC power from the load. Transistor M1 can block the positive AC half cycle, and transistor M2 can block the negative half cycle. When one transistor is turned on, current is conducted through the channel of that transistor as well as the integral body diode of the other transistor. Capacitor C1 and resistor R1 form a back EMF suppressor to filter out EMF noise from the load.

The conductive power loss P_{L} of the transistors is given by P_{L}=I²(2R) where I is the RMS value of the on-state current through the transistors, and R is the on-state resistance of each MOSFET. In some embodiments, the use of MOSFET transistors may result in lower power loss compared to some other switching circuits.

FIG. 13 illustrates another embodiment of a power switching circuit suitable for use with the fan speed controller of FIG. 11, as well as other embodiments of AC power controllers according to some inventive principles of this patent disclosure. The circuit of FIG. 13 includes two triacs U1 and U2 arranged in parallel between the hot terminal of the AC power source and the load. The gate of U1 is driven by a first gate signal GATE1 which applies a positive gate current I+ to trigger U1, while the gate of U2 is driven by a second gate signal GATE2 which applies a negative gate current I− to trigger U2. Each triac only needs to be gated right after the AC zero crossing for its associated half cycle. The triac switch is turned on by injecting the positive or negative current into the triac gate, depending on the polarity of the voltage across the triac. After current flow is established in the triac, it latches in the on state and automatically turns itself off at the next zero crossing of the AC voltage or when the voltage across the triac is near zero. Capacitor C1 and resistor R1 form a back EMF suppressor to filter out EMF noise from the load.

An inductive load such as a fan may generate high back EMF noise voltage resulting in a reversal of the voltage polarity across the triac which may turn the triac off. Using two parallel triacs, and applying a positive gate current to one and a negative gate current to the other may assure that one triac switch is always on independent of the voltage polarity across the triacs. Two current drivers may be used to gate the two triacs.

The power loss P_{L} of the triacs is given by P_{L}=IV_{T} where I is the RMS value of the on-state current through the conducting triac, and V_{T} is the on-state voltage drop across the triac, typically about 1.4 volts. In some embodiments, the use of triacs may result in a lower cost compared to some other switching circuits.

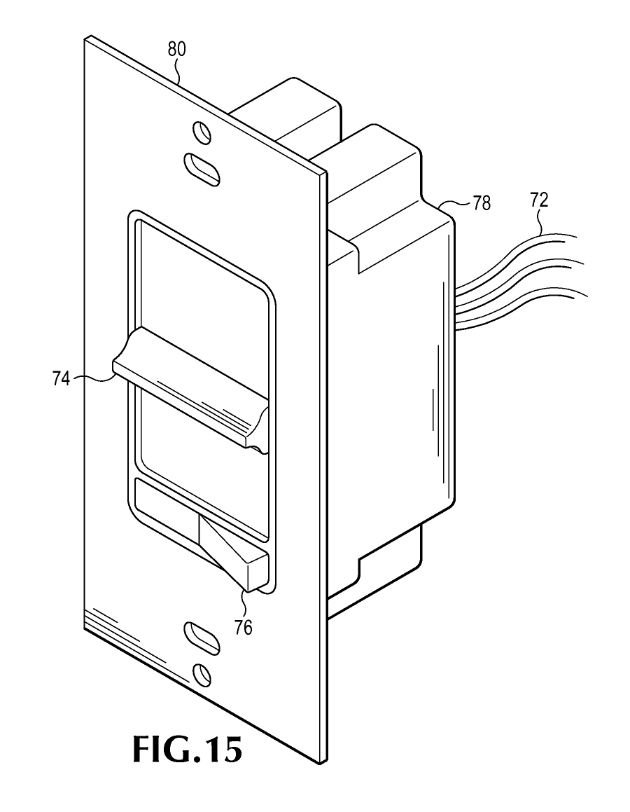

FIG. 14 illustrates another embodiment of a power switching circuit for use with the fan speed controller of FIG. 11, as well as other embodiments of AC power controllers according to some inventive principles of this patent disclosure. The circuit of FIG. 14 includes a single triac U1 connected between the hot terminal of the AC power source and the load. The gate of U1 is driven by an optical pilot driver having an opto-triac (OC1). The opto-triac is gated on by driving its LED input with a current at the I_GATE terminal. The pilot bridges the low impedance path formed by resistors R3 and R2 between the triac gate and the load terminal, thus, keeping the triac switched on independent of the voltage polarity across the triac.

In some embodiments, the use of a single power switching triac gated by an opto-triac pilot may provide a lower cost compared to some other switching circuits.

In some embodiments, the fan speed controller of FIG. 11 may be implemented as a wiring device as shown in FIG. 15. In this example, the controller is configured as a single-gang or single-strap wiring device for a standard electrical wallbox. The hot, neutral and load terminal are implemented as pigtail leads 72, but screw terminals, spring contacts, or any other suitable connection technique may be used. A slide switch 74 provides the speed control input, and a rocker switch 76 provides the on/off function, but other types of speed control inputs and on/off switches may be used. The controller is enclosed in a housing 78 having a face plate 80 for mounting the controller in a wallbox.

Various inventive principles of this patent disclosure may provide valuable benefits when implemented in an embodiment like the fan speed controller of FIG. 15. For example, wiring devices tend to become commoditized and highly price sensitive, not only in terms of manufacturing costs, but also installation and operating costs. The use of full cycle power control according to some inventive principles of this patent disclosure may help reduce all of these costs. For example, in some embodiments, a single triac or transistor switching circuit may be used as the power switch. This is in contrast to a conventional wiring device fan speed controller which requires multiple triacs and RC dampers to achieve multiple speed control. Thus, the cost of triacs and damper circuits may be reduced.

Moreover, triacs or other switches and damper components generate heat which wastes energy and must be removed from the controller. Eliminating these components may also eliminate their associated heat sinking and/or removal apparatus which may further reduce the manufacturing costs, and may also reduce the size of the wiring device so that it fits more easily into an electrical box, thereby reducing installation costs. Further, reducing or eliminating the heat dissipation from switches and RC dampers may conserve energy and reduce operating costs.

Some additional benefits of full cycle power control according to some inventive principles of this patent disclosure may stem from the ability to switch the state of a power switch at or near a zero cross. This may reduce or eliminate EMI which is harmful to other equipment in a building environment. In turn, this may reduce or eliminate the need for EMI suppression circuitry which may reduce both the power consumption and/or cost of the controller. Switching at or near zero crosses may also reduce inrush currents which may improve the reliability of both the controller, as well as the fan or other equipment being controlled. Reduced inrush currents may also reduce the size and cost of the power switch needed in the controller.

The ability to control multiple parallel fan motors and/or fan motors of different types and sizes from a single wiring device may also provide valuable benefits. Conventional fan speed controllers having multiple RC dampers for different motor speeds are only able to operate with specific types and sizes of fan motors. This increases the cost to manufacture, specify, order, stock, install, and inspect numerous models of controllers. It also may create safety hazards and reduce reliability because of the increased likelihood of installing the wrong controller. Because a fan speed controller according to some inventive principles of this patent disclosure may be able to control multiple parallel fan motors and/or fan motors of different types and sizes from a single wiring device, it may reduce or eliminate some or all of these problems.

In some other embodiments, a fan speed controller similar to the one described above with respect to FIGS. 11-15 may be implemented in a form factor suitable for use in an energy management and/or building automation system such as a system having a central distribution panel with modules for lighting control, fan control, etc. In yet other embodiments, such a fan speed controller may be realized in the form of a power pack where all or most of the components are located in a power pack housing, and a remote connection is provided for the speed selection input. For example, a low voltage (e.g. 24 volt DC) switch or digital switch may be used to provide the speed select input to the power pack, from where the full cycle switching circuitry controls a fan motor wired to the power pack.

In some other embodiments, a fan speed controller similar to the one described above with respect to FIGS. 11-15 may be adapted to control heaters, pumps, actuators, lights and/or any other type of electrical load. Moreover, such a controller may be implemented in a form factor other than a wiring device, for example, as a module for a panel, as a power pack, etc.

The inventive principles of this patent disclosure have been described above with reference to some specific example embodiments, but these embodiments can be modified in arrangement and detail without departing from the inventive concepts. For example, some of the embodiments have been described in the context of fan speed control, but the inventive principles apply to other types of electrical loads as well. Any of the control circuitry and logic described and claimed herein may be implemented in analog and/or digital hardware, software, firmware, etc., or any combination thereof. As another example, some of the embodiments have been described in the context of interior building spaces, but the inventive principles apply to exterior or hybrid spaces as well. Such changes and modifications are considered to fall within the scope of the following claims.

1. A method comprising:
generating a pattern of full cycles of AC power, where the pattern may include cycles having at least two different states; and
applying the pattern of full cycles of AC power to a load;
where the pattern has a length that is shorter than a perceptible response time of the load.

2. The method of claim 1 where the at least two states comprise an on state and an off state.

3. The method of claim 1 where the at least two states comprise a high voltage state and a low voltage state.

4. The method of claim 1 where the pattern may include first groups of full cycles having a first state and second groups of full cycles having a second state.

5. The method of claim 4 where the first groups have the most uniform number of full cycles permitted by the pattern length.

6. The method of claim 5 where the second groups have the most uniform number of cycles permitted by the pattern length.

7. The method of claim 4 where the first groups and the second groups are distributed as uniformly as permitted by the pattern length.

8. The method of claim 4 where the first groups have greater variations of numbers of full cycles than are permitted by the pattern length.

9. The method of claim 1 where average power applied to the load is determined by the ratio of the number of cycles having a first state to the number of cycles having the second state.

10. The method of claim 9 further comprising generating different patterns for different power levels.

11. The method of claim 10 where the different patterns for different power levels have the same pattern length.

12. The method of claim 1 where the load comprises a fan motor.

13. The method of claim 1 where the load comprises a heater.

14. A power controller comprising:
a power switch to selectively couple an AC power source to a load; and
a controller to control the power switch;
where the controller includes logic to:
generate a pattern of full cycles of an AC waveform, where the pattern may include cycles having at least two different states; and
drive the power switch with the pattern;
where the pattern has a length that is shorter than a perceptible response time of the load.

15. The power controller of claim 14 where the power controller comprises a wiring device.

16. The power controller of claim 14 where the power controller comprises a module.

17. The power controller of claim 14 where the at least two different states comprise on states and off states.

18. The power controller of claim 14 where the controller includes logic to generate different patterns for different power levels.

19. A wiring device comprising:
a first terminal to couple the wiring device to a source of AC power;
a second terminal to couple the wiring device to a load;
a switch coupled between the first and second terminals; and
a controller to cause the switch to selectively couple full cycles of AC power from the first terminal to the second terminal.

20. The wiring device of claim 19 where the full cycles of AC power are arranged in a pattern having a length that is shorter than a perceptible response time of the load.

21. The wiring device of claim 19 where the full cycles of AC power are arranged in different patterns for different power levels.

22. The wiring device of claim 19 where the full cycles of AC power comprise full on cycles and full off cycles.

23. The wiring device of claim 19 where the wiring device is configured to fit in a standard electrical box.

24. The wiring device of claim 23 where the standard electrical box comprises a wallbox.

25. The wiring device of claim 24 where the wiring device is configured to occupy a single gang position.

26. The wiring device of claim 25 where the wiring device comprises a fan speed controller.

27. A method comprising:
coupling a wiring device having a power switch between an AC power source and a load;
controlling the switch to selectively couple full cycles of power from the AC power source to the load.

28. The method of claim 27 where the full cycles of AC power are arranged in a pattern having a length that is shorter than a perceptible response time of the load.

29. The method of claim 27 where the full cycles of AC power are arranged in different patterns for different power levels.

30. The method of claim 27:
where the load comprises a first load; and
further comprising coupling a second load in parallel with the first load.

31. The method of claim 30 where the first and second loads have substantially different impedances.
